(19) United States
(12) Patent Application Publication
(10) Pub. No.: US 2012/0151774 A1
(43) Pub. Date: Jun. 21, 2012

(54) ELECTRIC SHAVER

(75) Inventors: Hiroaki Shimizu, Shiga-ken (JP); Shunsuke Komori, Shiga-ken (JP); Jyuzaemon Iwasaki, Shiga-ken (JP); Toshio Ikuta, Shiga-ken (JP); Shin Hosokawa, Shiga-ken (JP)

(73) Assignee: Panasonic Corporation, Osaka (JP)

(21) Appl. No.: 13/392,903

(22) PCT Filed: Sep. 22, 2010
(86) PCT No.: PCT/JP2010/066378

§ 371 Date: Feb. 28, 2012

(30) Foreign Application Priority Data
Sep. 25, 2009 (JP) 2009 221333

(51) Int. Cl. B26B 19/10

(52) U.S. Cl. 30/43.92

(57) ABSTRACT

An electric shaver (11) is provided with a grip section (12) and a head (13) which is provided at the upper end of the grip section (12). Five outer blades (20) into which body hair can be introduced are provided at the upper end of the head (13) and arranged side by side in the front-rear direction (X) of the head (13). Each of the outer blades (20) is provided thereinside with an inner blade (30), which can reciprocate in the widthwise direction (Y) of the head (13) and cuts and removes body hair, which is introduced into the outer blade (20), by sandwiching the body hair between the inner blade (30) and the outer blade (20). The outer blades (20) include a slit blade (21) which is located at the center of the outer blades (20) in the front-rear direction (X), and net blades (22-25), a pair of which is provided at each side of the head (13) in the front-rear direction (X) of the head (13) and centered about the slit blade (21). The net blades (22-25) are symmetrical about the slit blade (21) in the front-rear direction (X) of the head (13).

### TECHNICAL FIELD

The present invention relates to an electric shaver used to shave body hair such as facial hair.

### BACKGROUND ART

Electric shavers have been proposed that include outer blades provided on the upper end of a head and inner blades provided on the inner side of the outer blades. The outer blades, which are capable of drawing in body hair, are parallel and arranged along its shorter dimension, which is the front-back direction of the head. The inner blades reciprocate in the longitudinal direction of the outer blades, that is, the width direction of the head. The body hair drawn in the adjacent outer blades is nipped by the inner blades and the outer blades to be cut. Also, electric shavers that include two slit blades and two net blades as the outer blades have been proposed (for example, see Patent Document 1). The slit blades include slits extending in the shorter dimension of the slit blades so that it is easy to shave long hair. The net blades have meshes so that it is easy to shave short hair.

According to such an electric shaver, when a user moves or slides the electric shaver on the target skin in the front-back direction of the head, facial hair is sequentially shaved by the four outer blades (slit blades and net blades) and the inner blades. Accordingly, an excellent finish is efficiently achieved with less reciprocation and without leaving unshaved hair.

### Prior Art Document

### Patent Document

### Patent Document 1: Japanese Laid-Open Patent Publication No. 2005-40358

### SUMMARY OF THE INVENTION

### Problems that the Invention is to Solve

In the above-mentioned electric shaver, five or more outer blades may be parallel and arranged along the front-back direction of the head to more efficiently achieve an excellent finish. In such an electric shaver, there is a room for improvement in the respect of optimizing the arrangement of the outer blades (slit blades and net blades). There is also a room for improvement in increasing the convenience of the electric shaver.

Accordingly, it is an object of the present invention to provide a convenient electric shaver that efficiently achieves an excellent finish.

### Means for Solving the Problems

In accordance with one aspect of the present invention, an electric shaver is provided. The electric shaver includes a grip section, which can be gripped by a user, a head provided at an upper end portion of the grip section, a plurality of parallel outer blades, and a plurality of inner blades. The outer blades are arranged on an upper end of the head and along the short dimension of the outer blades, which is a front-back direction of the head. Each inner blade is provided on the inner side of one of the outer blades. The inner blades are capable of reciprocating in a longitudinal direction of the outer blades, which is a width direction of the head, and the inner blades nip body hair drawn in the outer blades between the inner blades and the outer blades to cut the body hair. The outer blades include five or more parallel outer blades arranged along the front-back direction of the head. The outer blades include a slit blade and a plurality of net blades. The slit blade is arranged at the center of the outer blades in the front-back direction, and includes a plurality of slits arranged along the short dimension of the outer blades. The net blades are arranged on each side of the slit blade in the front-back direction of the head, and have meshes. The net blades are arranged to be symmetrical with respect to the slit blade in the front-back direction of the head.

Tops of the net blades are preferably symmetrical with respect to the slit blade in the front-back direction of the head.

The tops of a pair of the net blades arranged on both edges of the head in the front-back direction are preferably lower than the tops of the other net blades.

The tops of a pair of the net blades arranged on both edges of the head in the front-back direction are preferably higher than the tops of the other net blades.

The electric shaver preferably includes a cap detachably mounted on the head to cover at least part of the upper end portion of the head, and the cap preferably includes an opening portion, which exposes either the net blades at the front side of the head in the front-back direction or the net blades on the back side. The cap is preferably formed to be detachable such that the opening is arranged to correspond to either the net blades on the front side or the net blades on the back side.

The top of the net blade arranged on one edge of the head in the front-back direction is preferably set to be lower than the other net blades.

### BRIEF DESCRIPTION OF THE DRAWINGS

FIG. 1 is a schematic perspective view illustrating an electric shaver according to one embodiment of the present invention;

FIG. 2 is a schematic side view illustrating the head of the electric shaver of FIG. 1;

FIG. 3 is a schematic side view illustrating a head according to a modification;

FIG. 4 is a schematic side view illustrating a head according to a modification;

FIG. 5 is a schematic side view illustrating a head according to a modification; and

FIG. 6 is a schematic side view illustrating a head having a cap according to a modification.

### MODES FOR CARRYING OUT THE INVENTION

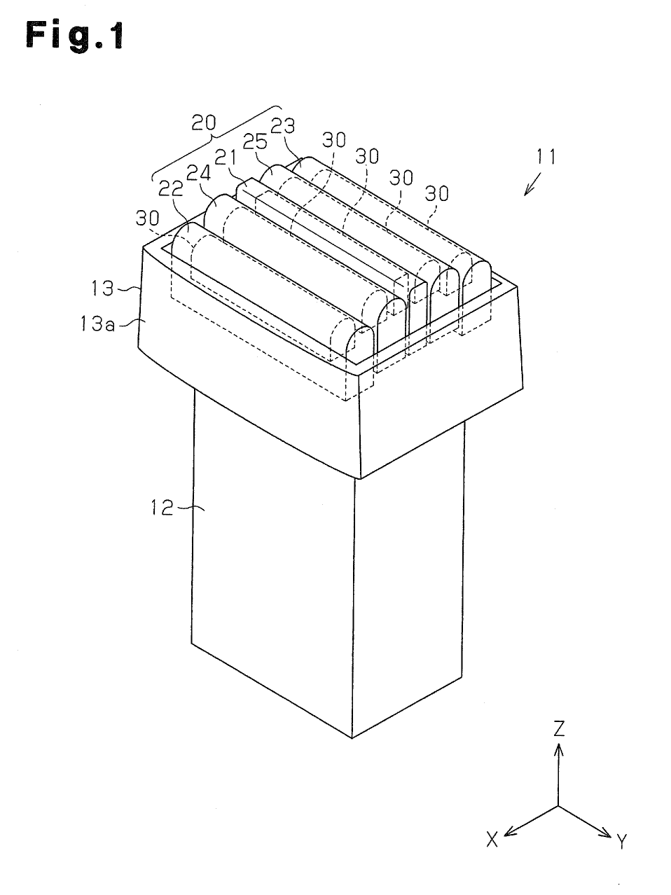

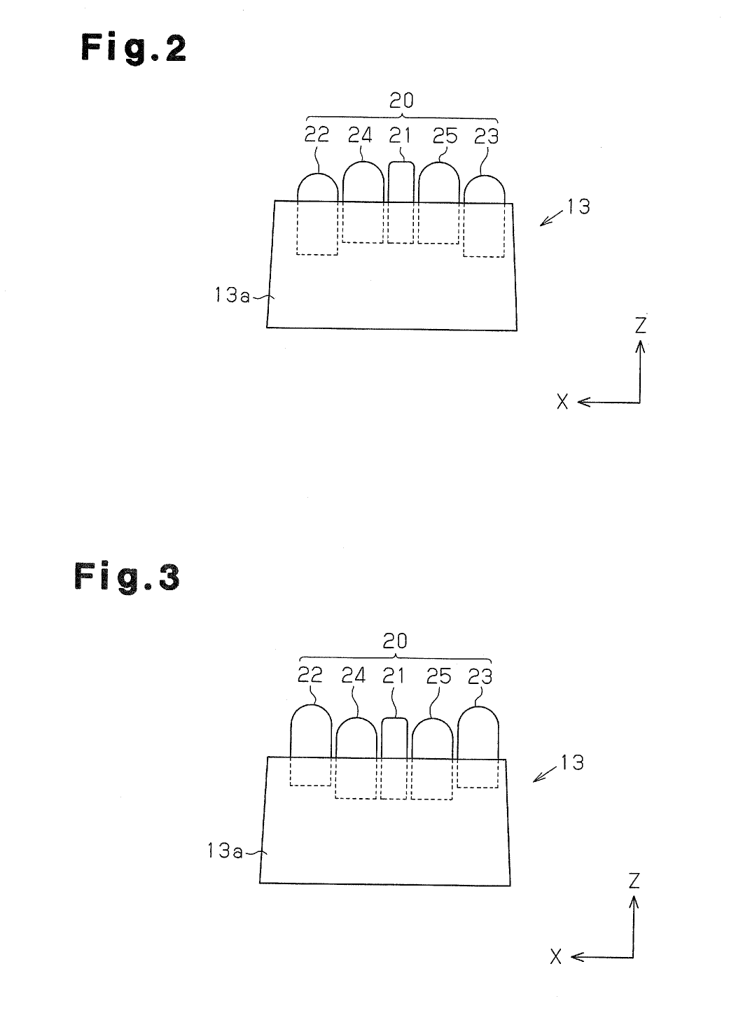

An electric shaver according to one embodiment of the present invention will now be described with reference to FIGS. 1 and 2.

As shown in FIG. 1, an electric shaver 11 for facial hair includes a grip section 12, which can be gripped by a user, and a head 13, which is provided on the upper end portion of the grip section 12. The head 13 is provided on the grip section 12 to be able to perform, for example, three kinds of operations. A first operation is a tilting operation about an axis (X-axis) extending in a front-back direction X (shaving direction) of the head 13. A second operation is a tilting operation about an axis (Y-axis) extending in a width direction Y (a direction perpendicular to the shaving direction) of the head 13. A third operation is reciprocation (vibration) in an up-and-down direction, that is, a vertical direction Z. The front-back direction X, the width direction Y, and the up-and-down direction or the vertical direction Z of the electric shaver 11 are perpendicular to one another.

Outer blades 20, which are capable of drawing in body hair, are provided on the upper end of the head 13, or more specifically, the upper opening of a head case 13a. The outer blades 20 are parallel and arranged along its short dimension, that is, the front-back direction X of the head 13. Also, inner blades 30 are respectively provided inside of the outer blades 20 of the head 13. The inner blades 30 reciprocate in the longitudinal direction of the outer blades 20, that is, the width direction Y of the head 13. The body hair drawn in the adjacent outer blades 20 is nipped between the inner blades 30 and the outer blades 20 to be cut. The outer blades 20 are secured to a non-illustrated plastic support frame and constitute an outer blade block together with the plastic support frame. The plastic support frame is supported to be movable with respect to the head case 13a in the up-and-down direction or the vertical direction in a predetermined range, and is urged upward by a non-illustrated spring. Accordingly, the plastic support frame can move downward by pressure from above. Also, the inner blades 30 are secured to a non-illustrated plastic support frame, and constitute an inner blade block together with the plastic support frame. The plastic support frame is coupled to a non-illustrated drive shaft, which reciprocates in the width direction Y of the head 13. The drive shaft is driven by, for example, a drive source (motor) provided inside the head 13, or inside the grip section 12.

The outer blades 20 of the present embodiment are five bladed including five outer blades that are parallel and arranged along the front-back direction X of the head 13. The five outer blades 20 include one slit blade 21 and four net blades 22 to 25. The slit blade 21 is arranged at the center of the front-back direction X of the head 13, and includes slits (not shown), which extend in its short dimension (front-back direction X). The net blades 22 to 25 are arranged on each side of the slit blade 21 two by two in the front-back direction X of the head 13. The net blades 22 to 25 have meshes (not shown). In the slit blade 21, the length and the width of the slits extending in the front-back direction X of the head 13 are set such that long hair is easily shaved. Also, the net blades 22 to 25 have meshes to easily shave short hair. Further, the net blades 22 to 25 are symmetrical with respect to the slit blade 21 in the front-back direction X of the head 13. In other words, the net blades 22 to 25 are in line symmetry with respect to the Y-axis, that is, the slit blade 21.

More specifically, the net blades 22 to 25 include normal net blades 22, 23 and finishing net blades 24, 25. The normal net blades 22, 23 are arranged on both edges of the head 13 in the front-back direction X. Each of the net blades 22, 23 has a number of frame-like outer blade elements constituting the mesh. The thicknesses of the outer blade elements are set to be substantially constant. The outer blade elements include a number of first outer blade elements, which are parallel and arranged substantially along one direction, and a number of second outer blade elements, which connect the first outer blade elements with one another and are parallel and arranged substantially along the direction perpendicular to the first outer blade elements.

The finishing net blades 24, 25 are respectively arranged between the normal net blades 22, 23, which are arranged on both edges of the head 13 in the front-back direction X, and the slit blade 21. The finishing net blades 24, 25 include a number of frame-like outer blade elements, which constitute the mesh. The outer blade elements include a number of first outer blade elements, which are parallel and arranged substantially along one direction, and a number of second outer blade elements, which connect the first outer blade elements with one another and are parallel and arranged substantially along the direction perpendicular to the first outer blade elements. In the finishing net blades 24, 25, the thickness of the outer blade elements is made partially thin so that short curly facial hair is also easily shaved. For example, only the second outer blade elements are made thinner than the first outer blade elements.

As shown in FIG. 2, when pressure is not applied to the net blades 22 to 25 from above, the net blades 22 to 25 are arranged at an initial position, where the net blades 22 to 25 are not moved downward. At the initial position, the tops of the net blades 22 to 25 are set to be symmetrical with respect to the slit blade 21 in the front-back direction X of the head 13. In other words, the tops of the net blades 22 to 25 are set to be in line symmetry with respect to the Z-axis, or the slit blade 21. More specifically, in the present embodiment, both the normal net blades 22, 23, which are arranged on both edges of the head 13 in the front-back direction X, are set to be lower than other finishing net blades 24, 25 by the same amount at the initial position. Also, in the present embodiment, the finishing net blades 24, 25 and the slit blade 21 are set at the same height at the initial position.

The present embodiment has the following advantages.
(1) Since the five outer blades 20 (the slit blade 21 and the net blades 22 to 25) are parallel and arranged along the front-back direction X of the head 13, an excellent finish is achieved more efficiently with less reciprocation as compared to the electric shaver in which four outer blades are arranged in parallel. Also, when the electric shaver 11 is caused to abut against the skin from one end of the head 13 in the front-back direction X, and moved or slid, the area on which the slit blade 21 contacts the skin tends to be small, and partially contacts the skin with great pressure, which is likely to damage the skin. The slit blade 21 is arranged at the center of the front-back direction X of the head 13, and the net blades 22, 23, which are not likely to damage the skin, are arranged on both edges of the head 13 in the front-back direction. This reduces the case in which the slit blade 21 independently contacts the skin with great pressure, thus reducing damage on the skin. Furthermore, the net blades 22 to 25, which are arranged two by two in the front-back direction X of the head 13 with the slit blade 21 at the center, are symmetrical with respect to the slit blade 21 in the front-back direction X of the head 13. In other words, the net blades 22 to 25 are in line symmetry with respect to the Y-axis, that is, the slit blade 21. Therefore, for example, when the outer blades 20 are caused to abut against the skin and moved or slid from either end of the head 13 in the front-back direction X (from the front side or the back side), the same finish is achieved. Therefore, for example, since it is unnecessary to slide in a predetermined direction to achieve a consistent excellent finish, convenience is improved.
(2) The tops of the net blades 22 to 25 are set to be symmetrical with respect to the slit blade 21 in the front-back direction as shown in FIG. 2. In other words, the tops of the net blades 22 to 25 are set to be in line symmetry with respect to the Z-axis, or the slit blade 21. Therefore, when the outer blades 20 are caused to abut against the skin, and moved or slid from either ends of the head 13 in the front-back direction X (from the front side or the back side), the same finish is achieved.
(3) Both the normal net blades 22, 23 arranged on the edges of the head 13 in the front-back direction X are set to be lower than other finishing net blades 24, 25 by the same amount. Therefore, the entire outer blades 20 are formed into a convex shape as viewed from the width direction Y of the head 13 (see FIG. 2). Thus, the outer blades 20 easily fit the concave part (hollow) such as under the chin, and an excellent finish is achieved at the concave part.

The present embodiment may be modified as follows.

In the above embodiment, both the normal net blades 22, 23 arranged on the edges of the head 13 in the front-back direction X are set to be lower than other finishing net blades 24, 25 by the same amount. However, for example, both the net blades 22, 23 arranged on the edges of the head 13 in the front-back direction X may be set to be higher than other net blades 24, 25 by the same amount as shown in FIG. 3. With this structure, the entire outer blades 20 form a concave shape as viewed from the width direction Y of the head 13 (see FIG. 3). Thus, the outer blades 20 easily fit a convex part such as the corner of the chin, and an excellent finish is achieved at the convex part. Also, when shaving the facial hair under the nose by the net blades 22, 23 arranged at the edges of the head 13 in the front-back direction X, the outer blades 20 (the finishing net blades 24, 25 and the slit blade 21) do not easily contact the lips.

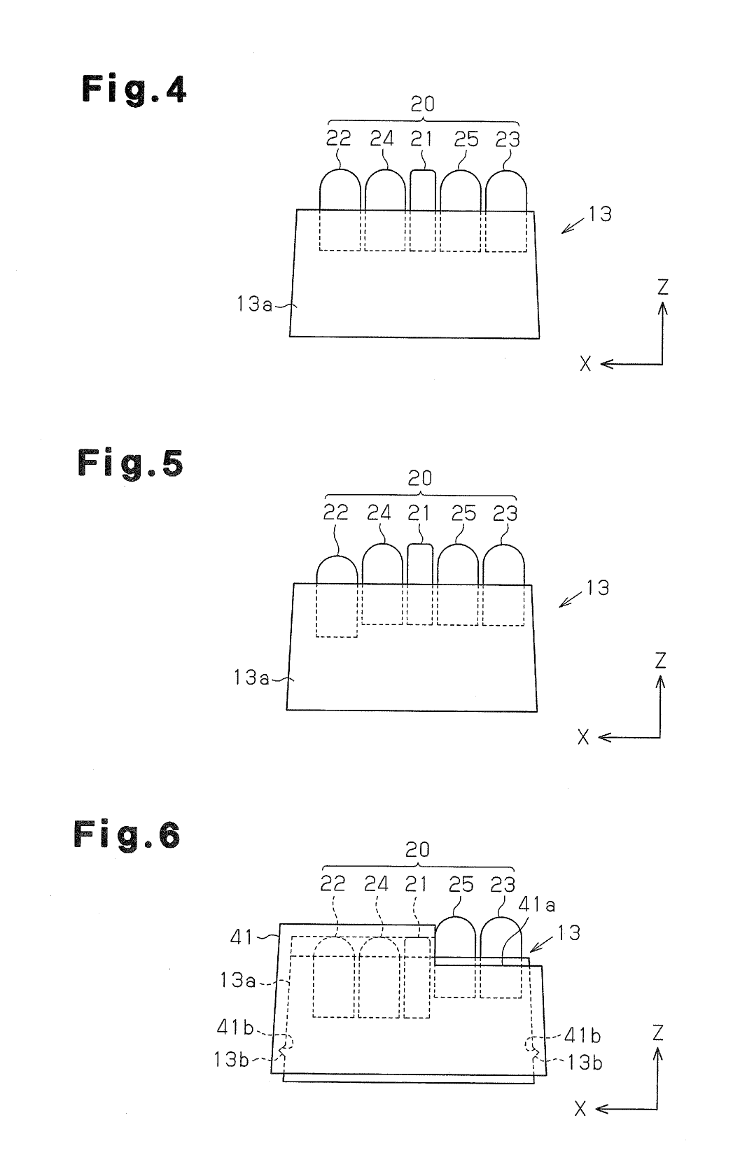

Also, for example, all the outer blades 20 (the slit blade 21, the normal net blades 22, 23, and the finishing net blades 24, 25) may be set to the same height at the initial position as shown in FIG. 4.

Furthermore, the tops of the net blades 22 to 25 do not need to be set symmetrical with respect to the slit blade 21 in the front-back direction X of the head 13. For example, the top of the net blade 22 arranged on one end of the head 13 in the front-back direction X may be set to be lower than other net blades 22 to 25 as shown in FIG. 5. With this structure, when shaving the facial hair under the nose, the net blade 22 arranged at the lower position on one end of the head 13 in the front-back direction X does not easily contact the lips. Therefore, user discomfort is reduced. Also, when shaving soft parts of the skin such as the cheeks, all the outer blades 20 (the slit blade 21, the normal net blades 22, 23, and the finishing net blades 24, 25) can be put in close contact with the skin regardless of the step (difference in height) of the net blade 22. Thus, an excellent finish is achieved.

In the above embodiment, although not particularly described, the shape of the upper ends of the outer blades 20 (the slit blade 21, the normal net blades 22, 23, and the finishing net blades 24, 25) may be straight, or curved into a convex shape as viewed from the front-back direction X of the head 13.

A cap that covers at least part of the upper end portion (the outer blades 20) may be detachably mounted on the upper end portion of the head 13 according to the above embodiment and the modification. For example, a cap 41 has an opening portion 41a, which exposes either the net blades 22, 24 on the front side of the head 13 in the front-back direction X, or the net blades 23, 25 on the back side as shown in FIG. 6. Also, the cap 41 is formed to be detachable such that the opening portion 41a is arranged on the back side. Specifically, the opening portion 41a can be arranged corresponding to either the net blades 22, 24 on the front side or the net blades 23, 25 on the back side. In this example, a pair of engaging projections 13b having the same shape are formed on both edges of the head case 13a in the front-back direction X. A pair of engaging recesses 41b having the same shape are formed on the cap 41. The engaging recesses 41b engage with the engaging projections 13b so that the cap 41 is retained to the head 13. Thus, the cap 41 is detachable to the head 13 as described above. All the outer blades 20 (the slit blade 21, the normal net blades 22, 23, and the finishing net blades 24, 25) of the head 13 in this example are set to the same height (see FIG. 4). FIG. 6 shows the state in which the cap 41 is mounted such that the opening portion 41a is arranged on the back side, and only the net blades 23, 25 are exposed outside. In this example (see FIG. 6), the slit blade 21 and the net blades 22, 24, which are not exposed, are moved downward by the pressure from above applied by the cap 41, and the net blades 23, 25, which are exposed from the cap 41 project upward.

With this structure, since the cap 41 can be attached to or detached from the head 13 with the position of the opening portion 41a of the cap 41 arranged on either the front or back of the head 13, the convenience is improved. Since the outer blades 20, which are not located at the opening portion 41a (the slit blade 21 and the net blades 22, 24 in FIG. 6), are not exposed outside, for example, when shaving the facial hair under the nose, the outer blades 20 do not easily contact the lips. Furthermore, since the net blades 22 to 25 (23, 25 in FIG. 6) are exposed in the same manner even when the position of the opening portion 41a is either on the front or back of the head 13, a consistent finish is achieved regardless of the position of the opening portion 41a.

In the above embodiment, the net blades 22 to 25 include the normal net blades 22, 23 and the finishing net blades 24, 25. However, other types of net blades may be used as long as the net blades, which are arranged on each side of the slit blade 21 in the front-back direction X of the head 13, are symmetrical with respect to the slit blade 21 in the front-back direction X of the head 13.

In the above embodiment and the modifications, five outer blades 20 are arranged in parallel in the front-back direction X of the head 13. However, six or more outer blades 20 may be arranged in parallel. When the number of the outer blades 20 is an even number, the slit blade 21 arranged at the center of the head 13 in the front-back direction X needs to be an even number. Also, when the number of the outer blades 20 is seven or more, six or more net blades may of course be provided. In this case, three or more net blades are provided on each side of the slit blade 21 in the front-back direction X of the head 13.

In the above embodiment, the present invention is applied to the electric shaver 11 for facial hair, but may be applied to electric shavers for shaving body hair other than facial hair.

### DESCRIPTION OF THE REFERENCE NUMERALS

12 . . . Grip Section

13 . . . Head

20 . . . Outer Blades

21 . . . Slit Blade, which is one of Outer Blades

22, 23 . . . Normal Net Blades, which are Outer Blades

24, 25 . . . Finishing Net Blades, which are Outer Blades

30 . . . Inner Blades

41 . . . Cap

41a . . . Opening Portion

X . . . Front-back Direction

Y . . . Widthwise Direction

Z . . . Up-and-down Direction, Vertical Direction

1. An electric shaver comprising:
a grip section, which can be gripped by a user;
a head provided at an upper end portion of the grip section;
a plurality of parallel outer blades arranged on an upper end of the head and along the short dimension of the outer blades, which is a front-back direction of the head; and
a plurality of inner blades each provided on the inner side of one of the outer blades, the inner blades being capable of reciprocating in a longitudinal direction of the outer blades, which is a width direction of the head, and the inner blades nip body hair drawn in the outer blades between the inner blades and the outer blades to cut the body hair,
the outer blades include five or more parallel outer blades arranged along the front-back direction of the head,
the outer blades include:
a slit blade arranged at the center of the outer blades in the front-back direction, the slit blade including a plurality of slits arranged along the short dimension of the outer blades; and
a plurality of net blades arranged on each side of the slit blade in the front-back direction of the head, the net blades having meshes,
wherein the net blades are arranged to be symmetrical with respect to the slit blade in the front-back direction of the head.

2. The electric shaver according to claim 1, wherein tops of the net blades are symmetrical with respect to the slit blade in the front-back direction of the head.

3. The electric shaver according to claim 2, wherein the tops of a pair of the net blades arranged on both edges of the head in the front-back direction are lower than the tops of the other net blades.

4. The electric shaver according to claim 2, wherein the tops of a pair of the net blades arranged on both edges of the head in the front-back direction are set to be higher than tops of the other net blades.

5. The electric shaver according to claim 1, further comprising:
a cap detachably mounted on the head to cover at least part of the upper end portion of the head,
wherein the cap includes an opening portion, which exposes either the net blades at the front side of the head in the front-back direction or the net blades on the back side, and wherein the cap is formed to be detachable such that the opening is arranged to correspond to either the net blades on the front side or the net blades on the back side.

6. The electric shaver according to claim 1, wherein the top of the net blade arranged on one edge of the head in the front-back direction is set to be lower than the other net blades.
